(19) United States
(12) Patent Application Publication
(10) Pub. No.: US 2026/0100805 A1
(43) Pub. Date: Apr. 9, 2026

(54) FREQUENCY DIVISION DUPLEXING IN PAIRED UPLINK AND DOWNLINK BANDS

(71) Applicant: QUALCOMM Incorporated, San Diego, CA (US)

(72) Inventors: Jae Ho RYU, San Diego, CA (US); Kianoush HOSSEINI, San Diego, CA (US); Marco PAPALEO, Bologna (IT)

(21) Appl. No.: 18/907,342

(22) Filed: Oct. 4, 2024

(51) Int. Cl. H04L 5/14; H04W 72/0453

(52) U.S. Cl. CPC H04L 5/14; H04W 72/0453

(57) ABSTRACT

Methods, systems, and devices for wireless communications are described. A user equipment (UE) may operate in a frequency division duplexing (FDD) mode using paired uplink and downlink bands. The UE may receive a first downlink reference signal in a first frequency band to determine one or more first channel conditions associated with the first frequency band, the first downlink reference signal associated with downlink communications. The UE may receive a second downlink reference signal in a second frequency band to determine one or more second channel conditions associated with the second frequency band, the second downlink reference signal associated with uplink communications. The UE may transmit one or more uplink signals in the second frequency band in accordance with one or more transmission parameters that are based on the one or more second channel conditions determined using the second downlink reference signal.

### FIELD OF TECHNOLOGY

The following relates to wireless communications, including frequency division duplexing (FDD) in paired uplink and downlink bands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Wireless communications devices may operate in a duplex mode, such as a frequency division duplexing (FDD) mode or a time division duplexing (TDD) mode. The FDD mode may include performing uplink communications and downlink communications in separate sub-bands.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first downlink reference signal in a first frequency band to determine one or more first channel conditions associated with the first frequency band, the first downlink reference signal associated with downlink communications, receiving a second downlink reference signal in a second frequency band to determine one or more second channel conditions associated with the second frequency band, the second downlink reference signal associated with uplink communications, and transmitting one or more uplink signals in the second frequency band in accordance with one or more transmission parameters that are based on the one or more second channel conditions determined using the second downlink reference signal.

A UE for wireless communications is described. The UE may include one or more memories storing processor executable code, and one or more processors coupled with the one or more memories. The one or more processors may individually or collectively be operable to execute the code to cause the UE to receive a first downlink reference signal in a first frequency band to determine one or more first channel conditions associated with the first frequency band, the first downlink reference signal associated with downlink communications, receive a second downlink reference signal in a second frequency band to determine one or more second channel conditions associated with the second frequency band, the second downlink reference signal associated with uplink communications, and transmit one or more uplink signals in the second frequency band in accordance with one or more transmission parameters that are based on the one or more second channel conditions determined using the second downlink reference signal.

Another UE for wireless communications is described. The UE may include means for receiving a first downlink reference signal in a first frequency band to determine one or more first channel conditions associated with the first frequency band, the first downlink reference signal associated with downlink communications, means for receiving a second downlink reference signal in a second frequency band to determine one or more second channel conditions associated with the second frequency band, the second downlink reference signal associated with uplink communications, and means for transmitting one or more uplink signals in the second frequency band in accordance with one or more transmission parameters that are based on the one or more second channel conditions determined using the second downlink reference signal.

A non-transitory computer-readable medium storing code for wireless communications is described. The code may include instructions executable by one or more processors to receive a first downlink reference signal in a first frequency band to determine one or more first channel conditions associated with the first frequency band, the first downlink reference signal associated with downlink communications, receive a second downlink reference signal in a second frequency band to determine one or more second channel conditions associated with the second frequency band, the second downlink reference signal associated with uplink communications, and transmit one or more uplink signals in the second frequency band in accordance with one or more transmission parameters that are based on the one or more second channel conditions determined using the second downlink reference signal.

Some examples of the method, UEs, and non-transitory computer-readable medium described herein may further include operations, features, means, or instructions for receiving, during an access procedure to a serving cell, a system information block (SIB) message that indicates a first set of parameters for the first frequency band and a second set of parameters for the second frequency band.

In some examples of the method, UEs, and non-transitory computer-readable medium described herein, the first set of parameters and the second set of parameters include different subcarrier spacings, absolute radio frequency channel numbers (ARFCNs), cyclic prefixes, or any combination thereof.

Some examples of the method, UEs, and non-transitory computer-readable medium described herein may further include operations, features, means, or instructions for receiving an indication of a first set of beam management resources associated with the first frequency band and receiving an indication of a second set of beam management resources associated with the second frequency band, where the second set of beam management resources may be different than the first set of beam management resources.

Some examples of the method, UEs, and non-transitory computer-readable medium described herein may further include operations, features, means, or instructions for measuring one or more downlink reference signals via the first set of beam management resources and reporting, via a component carrier associated with the downlink communications, a reference signal received power (RSRP), a signal-to-interference noise ratio (SINR), or both based on measuring the one or more downlink reference signals.

Some examples of the method, UEs, and non-transitory computer-readable medium described herein may further include operations, features, means, or instructions for measuring one or more downlink reference signals via the second set of beam management resources and reporting, via a first component carrier associated with the uplink communications and via a corresponding second component carrier associated with the downlink communications, a RSRP, a SINR, or both based on measuring the one or more downlink reference signals.

In some examples of the method, UEs, and non-transitory computer-readable medium described herein, the first frequency band and the second frequency band may be assigned a same band number, or the first frequency band may be assigned a first band number and the second frequency band may be assigned a second band number different than the first band number, the first band number and the second band number including a band number pair.

In some examples of the method, UEs, and non-transitory computer-readable medium described herein, the second downlink reference signal may be received via a serving cell of the UE.

In some examples of the method, UEs, and non-transitory computer-readable medium described herein, the second downlink reference signal may be received via a non-serving cell of the UE.

In some examples of the method, UEs, and non-transitory computer-readable medium described herein, the second downlink reference signal may be received via a same component carrier as or a different component carrier than a component carrier associated with the uplink communications.

In some examples of the method, UEs, and non-transitory computer-readable medium described herein, the second frequency band may be separated from the first frequency band by at least a threshold frequency separation.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support frequency division duplexing (FDD) in paired uplink and downlink bands in accordance with one or more aspects of the present disclosure.

FIGS. 3A and 3B show examples of reference signal configurations that support FDD in paired uplink and downlink bands in accordance with one or more aspects of the present disclosure.

FIG. 4 shows an example of a process flow that supports FDD in paired uplink and downlink bands in accordance with one or more aspects of the present disclosure.

FIGS. 5 and 6 show block diagrams of devices that support FDD in paired uplink and downlink bands in accordance with one or more aspects of the present disclosure.

FIG. 7 shows a block diagram of a communications manager that supports FDD in paired uplink and downlink bands in accordance with one or more aspects of the present disclosure.

FIG. 8 shows a diagram of a system including a device that supports FDD in paired uplink and downlink bands in accordance with one or more aspects of the present disclosure.

FIGS. 9 and 10 show flowcharts illustrating methods that support FDD in paired uplink and downlink bands in accordance with one or more aspects of the present disclosure.

### DETAILED DESCRIPTION

Some wireless communications devices may perform frequency division duplexing (FDD) communications, time division duplexing (TDD) communications, or both. For example, FDD communications may involve a frequency range being partitioned into a first subband allocated for downlink communications and a second subband allocated for uplink communications, where the first subband and the second subband are in a same frequency band. Alternatively, TDD communications may involve a time resource being partitioned into a first duration allocated for downlink communications and a second duration allocated for uplink communications, where the first duration and the second duration repeat in a TDD pattern. In some cases, wireless communications devices may perform a combination of FDD and TDD communications, such as subband full duplex TDD communications. For example, in sub-band duplex TDD communications, a downlink slot (e.g., a slot in the first duration allocated for downlink communications) may include both downlink and uplink communications in different subbands of a frequency band. In such cases, a network entity may simultaneously receive, in the downlink slot, uplink communications from a first user equipment (UE) in a first subband and transmit downlink communications to a second UE in a second subband. The subband full duplex TDD communications may be associated with performance improvements relative to FDD communications, TDD communications, or both, including reduced latency, enhanced coverage, flexible resource adaptation, or the like. However, the subband full duplex TDD communications may be associated with increased self-interference, cross-link interference, resource overhead, and scheduling complexity.

Wireless communications devices described herein may perform FDD communications in different frequency bands. For example, a network entity and a UE may perform downlink communications in a first frequency band and uplink communications in a second frequency band. In some examples of FDD, a UE may use a concept of channel reciprocity to determine channel conditions for both uplink and downlink. If a UE is using channel reciprocity, the UE may receive a downlink reference signal and measure channel characteristics of the downlink channel. If the associated uplink channel is sufficiently close in frequency to the downlink channel, the UE may then determine channel characteristics of the uplink channel based on the downlink reference signal received over the downlink channel, even though the frequencies of the uplink channel and the downlink channel are different. In examples in which wireless communications devices perform the FDD communications in different frequency bands, the UE may not be able to use channel reciprocity to determine transmission parameters for uplink communications based on downlink reference signals received in the first frequency band, as the downlink and uplink communications are performed in frequency bands that are too far apart (e.g., rather than different subbands of a same band). In such examples, the UE may receive and measure a downlink reference signal in the second frequency band, where the second frequency band is allocated for uplink communications. The UE may determine transmission parameters based on measuring the downlink reference signal and transmit uplink signals in accordance with the transmission parameters.

Aspects of the disclosure are initially described in the context of wireless communications systems. Aspects of the disclosure are also described in the context of reference signal configurations and process flows. Aspects of the disclosure are further illustrated by and described with reference to apparatus diagrams, system diagrams, and flowcharts that relate to FDD in paired uplink and downlink bands.

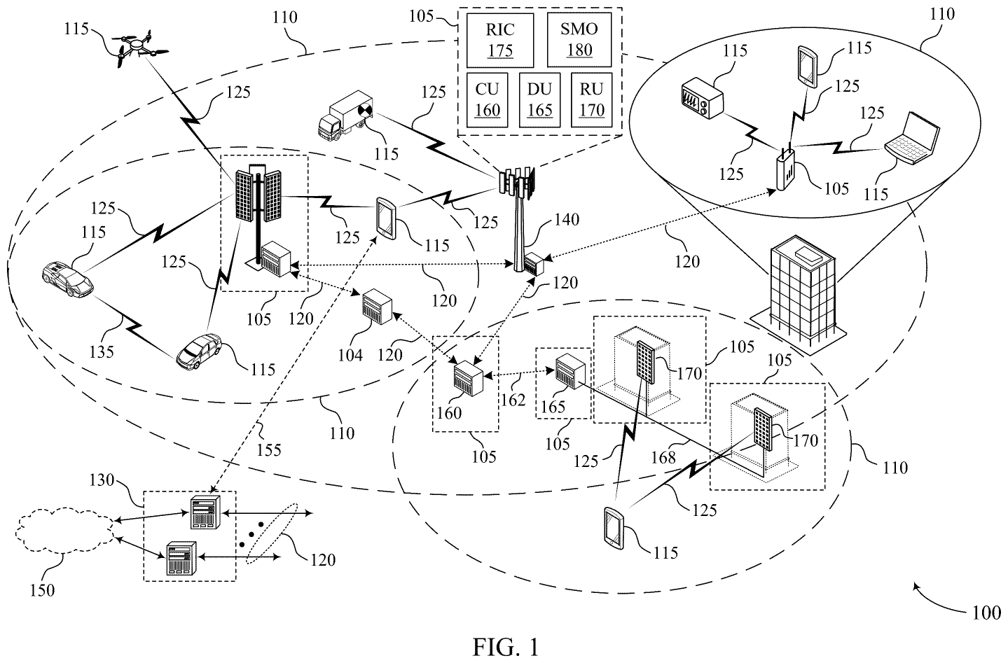

FIG. 1 shows an example of a wireless communications system 100 that supports FDD in paired uplink and downlink bands in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support FDD in paired uplink and downlink bands as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Some wireless communications devices may perform communications according to a duplex mode, such as according to an FDD mode or a TDD mode. The duplex mode may define how a spectrum is allocated for uplink communications (e.g., from the UE 115 to the network entity 105) and downlink communications (e.g., from the network entity 105 to the UE 115). For example, the FDD mode may allocate separate frequency ranges within a same frequency band for the uplink communications and the downlink communications. In other words, the FDD mode may involve a first frequency range allocated for uplink communications and a second frequency range allocated for downlink communications, where the first frequency range and the second frequency range are within a same frequency band. In such cases, the first frequency range and the second frequency range may be separated by a guard band. The guard band may enable radio frequency filters at receiving devices to separate uplink and downlink communications.

Additionally, or alternatively, the TDD mode may allocate separate time ranges for uplink communications and downlink communications. In other words, the TDD mode may involve a first duration in which downlink communications are performed and a second duration in which uplink communications are performed. In such cases, the first duration and the second duration may be separated by a guard time. Additionally, the first duration and the second duration may be part of a TDD pattern that is repeated. In some cases, FDD communications may support reduced latency compared to TDD communications, as uplink and downlink communications are capable of being exchanged simultaneously. However, FDD communications may be associated with higher complexity compared to TDD communications related to configuring paired uplink and downlink bands, configuring guard bands, implementing duplexers at wireless communications devices, and the like.

In some cases, wireless communications devices (e.g., the UE 115 and the network entity 105) may perform sub-band duplex operations within a TDD band. For example, wireless communications devices may operate according to a TDD mode, where, in at least some slots, there are resources allocated to both uplink and downlink communications. During the slots having allocations for both uplink and downlink communications, the network entity 105 may perform uplink communications with a first UE and downlink communications with a second UE.

As an example, in a TDD pattern including three downlink slots, a special slot, a guard time, and an uplink slot, the three downlink slots and the special slot may include resources allocated for uplink communications. As another example, in a TDD pattern including a first downlink slot, a first guard time, a second and third downlink slot, a special slot, a second guard time, and uplink slot, the second and third downlink slots and the special slot may include resources allocated for uplink communications. That is, the TDD pattern may include downlink slots having both downlink and uplink resources. In such cases, the network entity 105 may perform downlink communications a first subband and with the first UE and, simultaneously, perform uplink communications on a second, different subband with the second UE. The TDD patterns including slots in which downlink and uplink communications are performed on different subbands may be referred to as subband full duplex operations in a TDD band (e.g., full duplex at the network entity 105 and half duplex at the UE 115).

The subband full duplex operations in the TDD band may support latency reduction by enabling transmission of uplink channels, signals, or both in an uplink subband within downlink slots of a TDD pattern. Additionally, the subband full duplex operations in the TDD band may support uplink coverage enhancements, flexible or dynamic uplink and downlink resource adaptation according to uplink and downlink traffic, or both. However, the subband full duplex operations in the TDD band may be associated with self-interference, cross-link interference, or both at the network entity 105 and the UE 115. Additionally, the subband full duplex operations in the TDD band may be associated with increased resource overhead relative to FDD operations or TDD operations by involving both a guard band between the downlink and uplink subbands and a guard time between downlink and uplink slots, as well as increased complexity levels at the network entity 105 and the UE 115 to support scheduling.

As described herein, wireless communications devices may perform FDD operations in two different frequency bands. For example, the network entity 105, the UE 115, or both may perform FDD mode communications in a paired downlink channel and uplink channel in two different bands. These different frequency bands may be farther apart from each other (in frequency) than paired bands in other implementations. Examples of the paired bands in several implementations are described with reference to Table 1.

TABLE 1

| Implementation | Downlink Band | Uplink Band | |
|---|---|---|---|
| FR3 | 12-13 GHz | 8 | GHz |
| FR1-FR2 | 28 GHz | 3.7 | GHz |
| TDD-TDD band | 3.7 GHz | 2.5 | GHz |
| TDD-FDD band | 2.5 GHz | 800 | MHz |

The FDD mode communications in different frequency bands may be referred to as evolved FDD (e.g., eFDD). The FDD mode communications in the different frequency bands may support reduced implementation complexity compared to FDD mode communications. For example, FDD mode communications in the different frequency bands may not involve a guard band, radio frequency filtering, insertion loss, or the like. Additionally, the FDD mode communications in the different frequency bands may support improved communication compared to TDD mode communications, as downlink and uplink communications may be communicated simultaneously, which may support reduced latency.

Techniques described herein may support signaling for the FDD mode communications in different frequency bands (e.g., frequency bands that are sufficiently far apart in frequency that channel reciprocity principles do not apply). For example, as the uplink and downlink bands are separated by a greater frequency range than in FDD mode communications in a same frequency band, the UE 115 may not be able to apply channel reciprocity to apply measured channel characteristics of a downlink channel to transmission parameters for the uplink channel. Accordingly, the network entity 105 may configure a downlink reference signal in the uplink band to be measured for determination of transmission parameters for the uplink band. That is, the UE 115 may receive a downlink reference signal in a frequency band associated with uplink communications. Based on measuring the downlink reference signal in the frequency band, the UE 115 may determine transmission parameters for uplink signals in the frequency band.

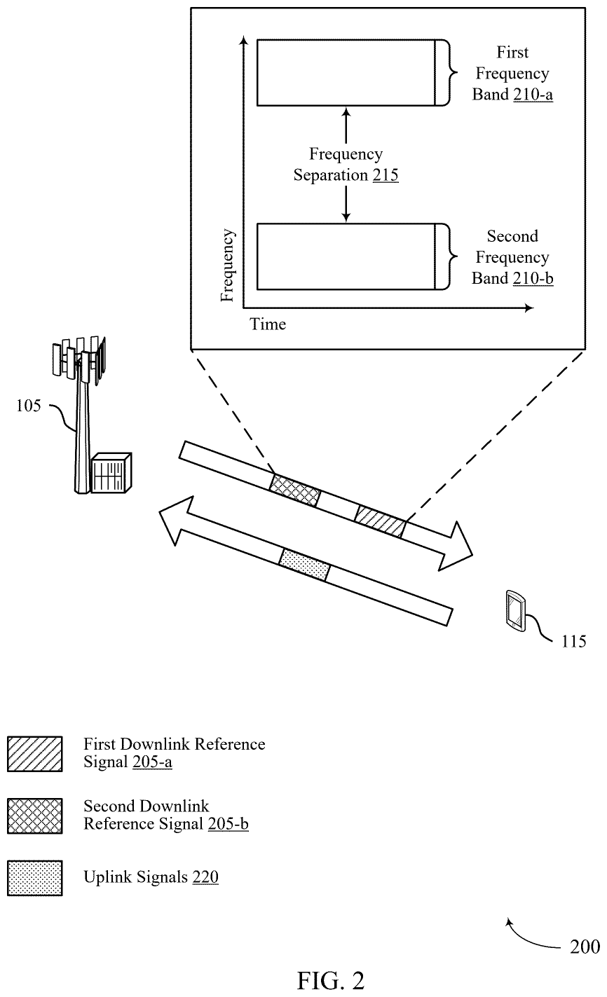

FIG. 2 shows an example of a wireless communications system 200 that supports FDD in paired uplink and downlink bands in accordance with one or more aspects of the present disclosure. The wireless communications system 200 may implement or be implemented by various aspects of the wireless communications system 100. For example, the wireless communications system 200 may include a network entity 105 and a UE 115 which may represent examples of corresponding devices as described with reference to FIG. 1.

The network entity 105 and the UE 115 may communicate in a first frequency band 210-a and a second frequency band 210-b that have a frequency separation 215. The first frequency band 210-a may be a downlink band, while the second frequency band 210-b may be an uplink band. That is, the first frequency band 210-a may be allocated for downlink communications while the second frequency band 210-b may be allocated for uplink communications. The frequency separation 215 between the first frequency band 210-a and the second frequency band 210-b may be larger than, as an example, a guard band between different subbands in an FDD operation involving two subbands within a same frequency band. The communication between the network entity 105 and the UE 115 in the first frequency band 210-a and the second frequency band 210-b may be referred to as FDD communications in paired uplink and downlink bands.

To determine transmission parameters for the second frequency band 210-b, the UE 115 may measure a downlink reference signal received in the second frequency band 210-b. That is, the UE 115 may receive a downlink reference signal in the second frequency band 210-b that is allocated for uplink communications rather than using a downlink reference signal received in the first frequency band 210-a allocated for downlink communications, as the first frequency band 210-a has a relatively large frequency separation 215 from the second frequency band 210-b compared to an FDD operation involving two subbands within a same frequency band.

For example, the network entity 105 may transmit a first downlink reference signal 205-a in the first frequency band 210-a, where the first downlink reference signal 205-a is associated with downlink communications. That is, the UE 115 may measure the first downlink reference signal 205-a and, in some examples, may report measurements of the first downlink reference signal 205-a to the network entity 105. In other words, the UE 115 may receive the first downlink reference signal to determine one or more first channel conditions associated with the first frequency band 210-a, which may be reported to the network entity 105. The network entity 105 may use the measurements of the first downlink reference signal 205-a or the one or more first channel conditions associated with the first frequency band 210-a to determine downlink transmission parameters for subsequent downlink transmissions (not shown) in the first frequency band 210-a.

Additionally, the network entity 105 may transmit a second downlink reference signal 205-b in the second frequency band 210-b, where the second downlink reference signal 205-b is associated with uplink communications. That is, the UE 115 may measure the second downlink reference signal 205-b and use the measurements to determine transmission parameters for uplink signals 220 in the second frequency band 210-b. In other words, the UE 115 may determine one or more second channel conditions associated with the second frequency band 210-b and, based on the determined one or more second channel conditions, determine one or more transmission parameters. The UE 115 may transmit the uplink signals 220 in the second frequency band 210-b and in accordance with the one or more transmission parameters.

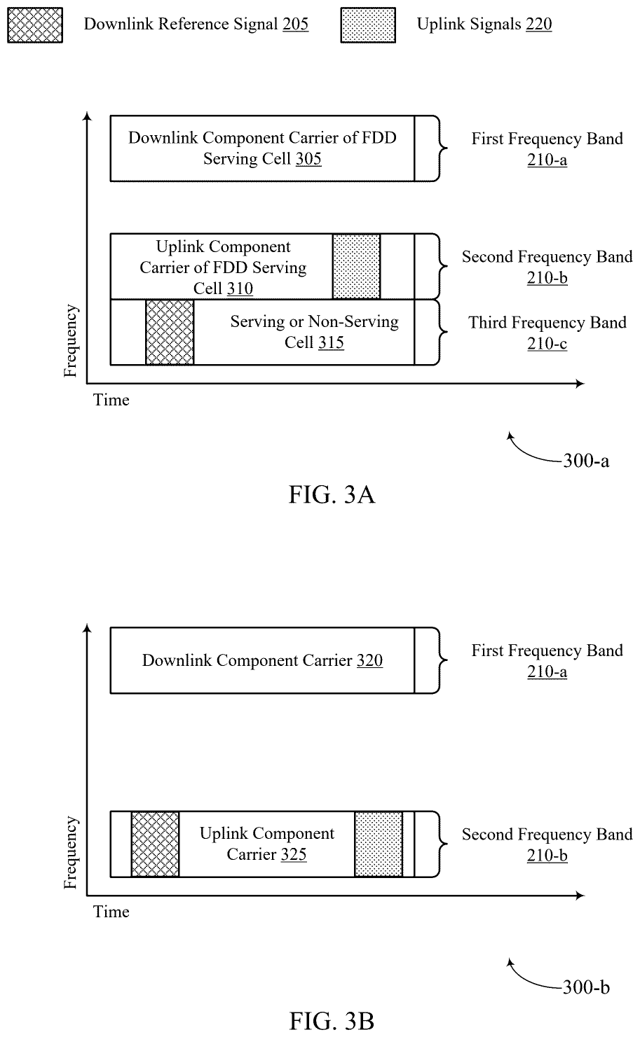

The second downlink reference signal 205-b may be an example of a pathloss reference signal. Additionally, or alternatively, the second downlink reference signal 205-b may be an example of a quasi co-located (QCL) reference signal (e.g., QCL type D reference signal). The UE 115 may use the second downlink reference signal 205-b for transmit beam derivation. Examples of downlink reference signals used for uplink transmit beam derivation, among other transmission parameters, may be described in greater detail elsewhere herein, including with reference to FIGS. 3A and 3B.

The first frequency band 210-a and the second frequency band 210-b may have a band number assignment. The band number assignments for the first frequency band 210-a and the second frequency band 210-b may be the same or different. For example, the first frequency band 210-a and the second frequency band 210-b may be assigned a band number that is associated with the pairing of the first frequency band 210-a and the second frequency band 210-b. An example of band numbers and associated pairings of downlink and uplink bands is provided with reference to Table 2.

TABLE 2

| Band Number | Downlink Band | Uplink Band |
|---|---|---|
| X | 12-13 GHz | 8-8.6 GHz |
| Y | 25-28 GHz | 3.6-3.8 GHz |
| Z | 3.6-3.8 GHz | 2.3-2.4 GHz |

Alternatively, the first frequency band 210-a and the second frequency band 210-b may have different band number assignments. For example, the first frequency band 210-a may be assigned a downlink band number. Examples of downlink band numbers and associated frequency bands are provided with reference to Table 3.

TABLE 3

| Downlink Band Number | Downlink Band |
|---|---|
| X_DL | 12-13 GHz |
| Y_DL | 25-28 GHz |
| Z_DL | 3.6-3.8 GHz |

The second frequency band 210-b may be assigned an uplink band number. Examples of uplink band numbers and associated frequency bands are provided with reference to Table 4.

TABLE 4

| Uplink Band Number | Uplink Band |
|---|---|
| X_UL | 8-8.6 GHz |
| Y_UL | 3.6-3.8 GHz |
| Z_UL | 2.3-2.4 GHz |

In examples in which the first frequency band 210-a and the second frequency band 210-b are assigned different band numbers, the pairing of the first frequency band 210-a and the second frequency band 210-b may be indicated as a pair of band numbers. Examples of pairs of the band numbers of Table 3 and Table 4 are provided with reference to Table 5.

TABLE 5

Band Number Pairing
{X_DL, X_UL}
{Y_DL, Z_UL}
{Z_DL, Z_UL}
{X_DL, Y_UL}

The network entity 105 may indicate the first frequency band 210-a and the second frequency band 210-b to the UE 115 via a band number or a band number pairing. For example, the network entity 105, the UE 115, or both may be preconfigured with one or more lookup tables that define band numbers corresponding to downlink bands, uplink bands, or both. By transmitting one or more signals including the indication of the band number, the network entity 105 may indicate, to the UE 115, bands on which downlink and uplink communications are to occur. In other words, the network entity 105 may transmit one or more control signals including an indication of a band number (e.g., from Table 2) or a band number pairing (e.g., from Tables 3-5). The network entity 105, the UE 115, or both may communicate in the downlink band and the uplink band in accordance with the band number.

The network entity 105 may transmit a system information block (SIB) message to the UE 115. For example, the network entity 105 may transmit the SIB message to the UE 115 during initial access, such as during an access procedure to a serving cell. The SIB message may include uplink carrier information, BWP information, or both. For example, the SIB message (e.g., SIB1) may include a serving cell configuration (e.g., servingCellConfigCommonSIB). The serving cell configuration may include an uplink configuration (e.g., UplinkConfigCommonSIB), including uplink frequency information (e.g., FrequencyInfoUL-SIB). The uplink frequency information may include an absolute radio frequency channel number (ARFCN). The ARFCN indicated in the uplink frequency information may be in a different band or frequency range than an ARFCN for downlink communications. Additionally, or alternatively, the SIB may indicate subcarrier spacings, a cyclic prefixes, or both associated with the first frequency band 210-a and the second frequency band 210-b. In other words, the SIB may indicate a first set of parameters associated with the first frequency band 210-a (e.g., downlink parameters) and a second set of parameters associated with the second frequency band 210-b (e.g., uplink parameters). The first and second sets of parameters may include ARFCNs, subcarrier spacings, cyclic prefixes, or any combination thereof.

The network entity 105 may configure separate beam management resources for downlink beam management and uplink beam management. For example, the network entity 105 may transmit an indication of a first set of beam management resources associated with the first frequency band 210-a (e.g., downlink beam management resources) and a second set of beam management resources associated with the second frequency band 210-b (e.g., uplink beam management resources), where the first set of beam management resources and the second set of beam management resources are different (e.g., separate). In other words, the network entity 105 may configure, for downlink beam management, downlink reference signal resources to measure and report a reference signal received power (RSRP) (e.g., an L1-RSRP), a signal-to-interference noise ratio (SINR) (e.g., an L1-SINR), or both on a downlink component carrier associated with the first frequency band 210-a. Additionally, the network entity 105 may configure, for uplink beam management, downlink reference signal resources to measure and report an RSRP (e.g., an L1-RSRP), a SINR (e.g., an L1-SINR), or both on an uplink component carrier associated with the second frequency band 210-b and a companion downlink component carrier. The network entity 105 may indicate the first and second sets of beam management resources via a same control message or different control messages.

The UE 115 may use the beam management resources to measure and report one or more measurement parameters. For example, the UE 115 may use downlink reference signal resources (e.g., the first set of beam management resources) to measure and report an RSRP (e.g., an L1-RSRP), a SINR (e.g., an L1-SINR), or both on a downlink component carrier associated with the first frequency band 210-a. Additionally, the UE 115 may use downlink reference signal resources (e.g., the second set of beam management resources) to measure and report an RSRP (e.g., an L1-RSRP), a SINR (e.g., an L1-SINR), or both on an uplink component carrier associated with the second frequency band 210-b and on a companion downlink component carrier associated with the uplink component carrier. In such examples, the companion downlink component carrier associated with the uplink component carrier may be a serving cell or a non-serving cell of the UE 115.

FIG. 3A shows an example of a reference signal configuration 300-a that supports FDD in paired uplink and downlink bands in accordance with one or more aspects of the present disclosure. The reference signal configuration 300-a may implement or be implemented by various aspects of the wireless communications system 100, the wireless communications system 200, or both. For example, the reference signal configuration 300-a may illustrate and describe communications between a network entity and a UE, which may represent examples of corresponding devices as described with reference to FIGS. 1 and 2.

In the example of FIG. 3A, wireless communications devices may perform FDD operations in a first frequency band 210-a in a downlink component carrier of an FDD serving cell 305 and in a second frequency band 210-b in an uplink component carrier of an FDD serving cell 310. The first frequency band 210-a and the second frequency band 210-b may be examples of paired bands. For example, wireless communications devices may perform downlink communications in the first frequency band 210-a and uplink communications in the second frequency band 210-b.

A wireless communications device, such as the UE 115 as described with reference to FIGS. 1 and 2, may receive a downlink reference signal 205 in the third frequency band 210-c from the serving or non-serving cell 315. The uplink component carrier of the FDD serving cell 310 and the serving cell or non-serving cell 315 may be co-located. The wireless communications device may receive the downlink reference signal 205 from the serving cell in examples in which the wireless communications device is configured with carrier aggregation (CA).

Alternatively, the wireless communications device may receive the downlink reference signal 205 from a non-serving cell. For example, the wireless communications device may receive the downlink reference signal 205 from the non-serving cell in examples in which the wireless communications device is configured with one serving cell. In such examples, the wireless communications device may receive the downlink reference signal 205 in a same component carrier as or a different component carrier than the uplink component carrier of the FDD serving cell 310.

In some examples, the serving cell or the non-serving cell 315 may be an example of a downlink cell. In such examples, the downlink component carrier of the FDD serving cell 305 and the serving or non-serving cell 315 may be synchronized. For example, the serving cell or the non-serving cell 315 may be synchronized with the downlink component carrier of the FDD serving cell 305 such that the wireless communication device may determine timing, frequency, or both of the downlink reference signal 205 from the downlink component carrier of the FDD serving cell 305. In other words, the wireless communications device may determine a timing, a frequency, or both of the downlink reference signal 205 based on the downlink component carrier of the FDD serving cell 305 and the serving or non-serving cell 315 being synchronized.

The wireless communications device may receive the downlink reference signal 205 in the third frequency band 210-c, where the third frequency band 210-c is proximate to the second frequency band 210-b. In other words, the wireless communications device may receive a downlink reference signal 205 in a frequency band associated with downlink or uplink communications that is adjacent to a frequency band associated with uplink communications. The wireless communications device may measure the downlink reference signal 205 to determine one or more channel conditions. By measuring the downlink reference signal 205 in the third frequency band 210-c, the wireless communications device may use the determined channel conditions to determine transmission parameters for uplink signals 220 in the second frequency band 210-b. That is, because the third frequency band 210-c is adjacent to the second frequency band 210-b, the wireless communications device may determine the transmission parameters for the uplink signals 220 in accordance with a channel reciprocity between the third frequency band 210-c and the second frequency band 210-b.

FIG. 3B shows an example of a reference signal configuration 300-b that supports FDD in paired uplink and downlink bands in accordance with one or more aspects of the present disclosure. The reference signal configuration 300-b may implement or be implemented by various aspects of the wireless communications system 100, the wireless communications system 200, or both. For example, the reference signal configuration 300-b may illustrate and describe communications between a network entity and a UE, which may represent examples of corresponding devices as described with reference to FIGS. 1 and 2.

In the example of FIG. 3B, wireless communications devices may perform FDD operations in a first frequency band 210-a for a downlink component carrier 320 and in a second frequency band 210-b for an uplink component carrier 325. The first frequency band 210-a and the second frequency band 210-b may be examples of paired bands. For example, wireless communications devices may perform downlink communications in the first frequency band 210-a and uplink communications in the second frequency band 210-b.

A wireless communications device may receive the downlink reference signal 205 in the second frequency band 210-b. For example, the uplink component carrier 325, the second frequency band 210-b, or both may support communication of the downlink reference signal 205 such that wireless communications devices may determine transmission parameters for the uplink signals 220. In other words, the uplink component carrier 325 and the second frequency band 210-b associated with uplink communications may be used to communicate at least downlink reference signals.

By measuring the downlink reference signal 205 in the second frequency band 210-b rather than in the first frequency band 210-a, the wireless communications device may determine transmission parameters that are applicable to transmissions on the second frequency band 210-b. That is, because the first frequency band 210-a and the second frequency band 210-b are different frequency bands (e.g., rather than subbands of a same frequency band), the wireless communications device may not apply channel reciprocity to apply channel characteristics of the first frequency band 210-a to the second frequency band 210-b.

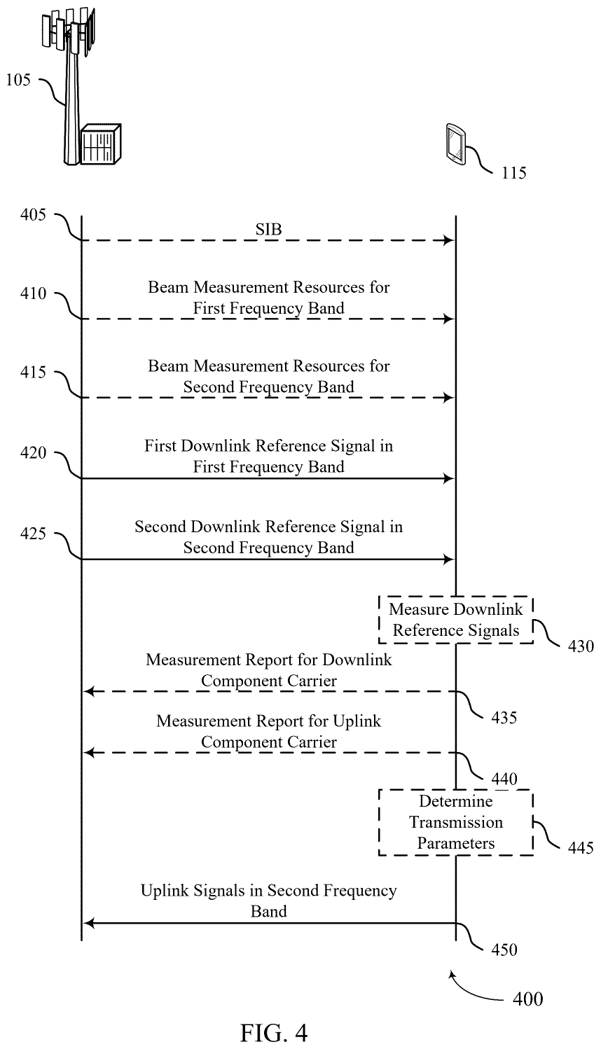

FIG. 4 shows an example of a process flow 400 that supports FDD in paired uplink and downlink bands in accordance with one or more aspects of the present disclosure. The process flow 400 may implement or be implemented by aspects of the wireless communications system 100, the wireless communications system 200, reference signal configuration 300-a, reference signal configuration 300-b, or any combination thereof. For example, the process flow 400 may include a network entity 105 and a UE 115 which may be examples of corresponding devices as described with reference to FIGS. 1 and 2.

Alternative examples of the following may be implemented, where some operations are performed in a different order than described or are not performed at all. In some cases, operations may include additional features not mentioned below, or further operations may be added. Although the network entity 105 and the UE 115 are shown performing the operations of the process flow 400, some aspects of some operations may also be performed by one or more other wireless devices.

At 405, the network entity 105 may output a SIB message to the UE 115. For example, the UE 115 may receive, during an access procedure to a serving cell, a SIB message that indicates a first set of parameters for a first frequency band and a second set of parameters for a second frequency band. The first set of parameters and the second set of parameters may include different subcarrier spacings, ARFCNs, cyclic prefixes, or any combination thereof. The first frequency band and the second frequency band may be examples of the first frequency band 210-a and the second frequency band 210-b, respectively, as described with reference to FIGS. 2, 3A, and 3B. The second frequency band is separated from the first frequency band by at least a threshold frequency separation, such as by the frequency separation 215 as described with reference to FIG. 2.

In some examples, the first frequency band and the second frequency band may be assigned band numbers. For example, the first frequency band and the second frequency band may be assigned a same band number. Assignment of the same band number for the first frequency band and the second frequency band may be described in greater detail elsewhere herein, including with reference to Table 2. Alternatively, the first frequency band may be assigned a first band number and the second frequency band may be assigned a second band number different than the first band number, where the first band number and the second band number are included in a band number pair. Assignment of different band numbers and band number pairs for the first frequency band and the second frequency band may be described in greater detail elsewhere herein, including with reference to Tables 3, 4, and 5.

At 410, the network entity 105 may output beam measurement resources for the first frequency band. For example, the UE 115 may receive an indication of a first set of beam management resources associated with the first frequency band. Additionally, at 415, the network entity 105 may output beam measurement resources for the second frequency band. For example, the UE 115 may receive an indication of a second set of beam management resources associated with the second frequency band, where the second set of beam management resources are different than the first set of beam management resources.

At 420, the network entity 105 may output a first downlink reference signal in a first frequency band. For example, the UE 115 may receive a first downlink reference signal in a first frequency band to determine one or more first channel conditions associated with the first frequency band, the first downlink reference signal associated with downlink communication. The first downlink reference signal may be an example of the first downlink reference signal 205-a as described with reference to FIG. 2.

At 425, the network entity 105 may output a second downlink reference signal in a second frequency band. For example, the UE 115 may receive a second downlink reference signal in a second frequency band to determine one or more second channel conditions associated with the second frequency band, the second downlink reference signal associated with uplink communications. The second downlink reference signal may be an example of the second downlink reference signal 205-b as described with reference to FIG. 2.

In some examples, the second downlink reference signal may be received via a serving cell of the UE 115. Alternatively, the second downlink reference signal may be received via a non-serving cell of the UE 115. In such examples, the second downlink reference signal may be received via a same component carrier as or a different component carrier than a component carrier associated with the uplink communications.

At 430, the UE 115 may measure downlink reference signals. For example, the UE 115 may measure one or more downlink reference signals via the first set of beam management resources. Additionally, the UE 115 may measure one or more downlink reference signals via the second set of beam management resources. In other words, the UE 115 may measure the downlink reference signals indicated by the first and second sets of beam measurement resources that are separately configured for the first frequency band and the second frequency band.

At 435, the UE 115 may output a measurement report for a downlink component carrier. For example, the UE 115 may report an RSRP, a SINR, or both based on measuring the one or more downlink reference signals in the first frequency band at 430. Additionally, at 440, the UE 115 may output a measurement report for an uplink component carrier. For example, the UE 115 may report an RSRP, a SINR, or both based on measuring the one or more downlink reference signals in the second frequency band at 430.

At 445, the UE 115 may determine transmission parameters. For example, the UE 115 may determine transmission parameters based on receiving the second downlink reference signal in the second frequency band at 425. That is, the UE 115 may determine transmission parameters for uplink signals based on receiving a downlink reference signal in an uplink frequency band. The UE 115 may determine the transmission parameters based on channel conditions of the second frequency band. For example, the UE 115 may determine the channel conditions of the second frequency band based on measuring the second downlink reference signal in the second frequency band at 425 and, based on the determined channel conditions, determine the transmission parameters.

At 450, the UE 115 may transmit uplink signals in the second frequency band. For example, the UE 115 may transmit one or more uplink signals in the second frequency band in accordance with one or more transmission parameters that are based on the one or more second channel conditions determined using the second downlink reference signal. That is, the UE 115 may transmit the one or more uplink signals in the second frequency band using the transmission parameters determined at 445.

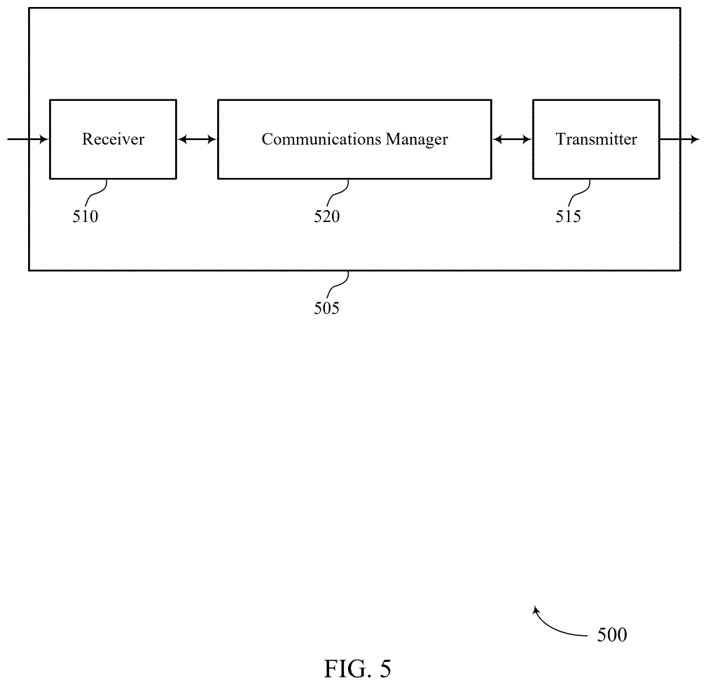

FIG. 5 shows a block diagram 500 of a device 505 that supports FDD in paired uplink and downlink bands in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to FDD in paired uplink and downlink bands). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to FDD in paired uplink and downlink bands). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of FDD in paired uplink and downlink bands as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a first downlink reference signal in a first frequency band to determine one or more first channel conditions associated with the first frequency band, the first downlink reference signal associated with downlink communications. The communications manager 520 is capable of, configured to, or operable to support a means for receiving a second downlink reference signal in a second frequency band to determine one or more second channel conditions associated with the second frequency band, the second downlink reference signal associated with uplink communications. The communications manager 520 is capable of, configured to, or operable to support a means for transmitting one or more uplink signals in the second frequency band in accordance with one or more transmission parameters that are based on the one or more second channel conditions determined using the second downlink reference signal.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced latency, improved coverage, more flexible resource adaptation, reduced interference, and more efficient utilization of communication resources.

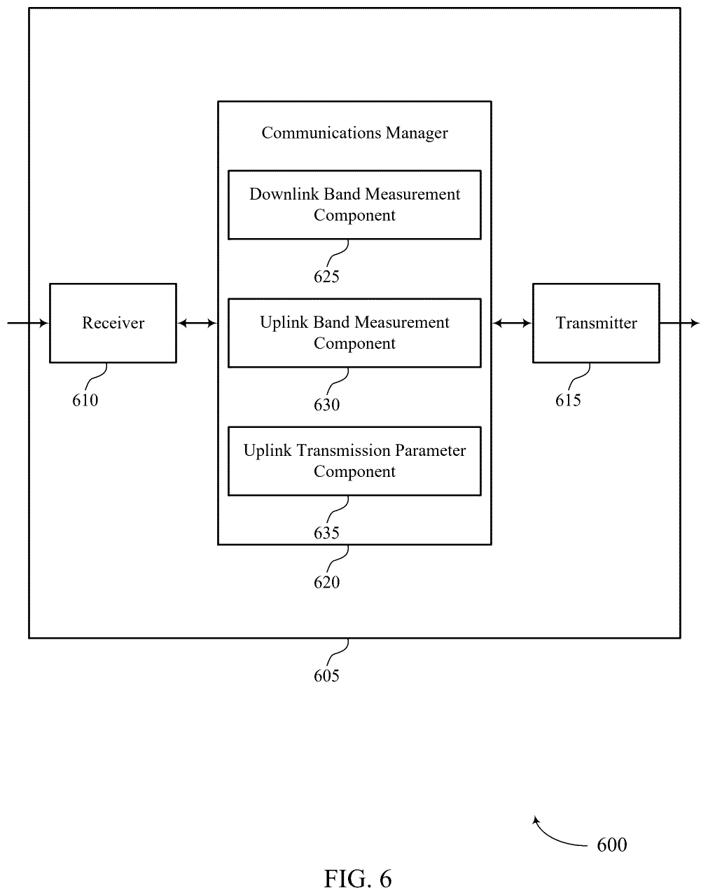

FIG. 6 shows a block diagram 600 of a device 605 that supports FDD in paired uplink and downlink bands in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to FDD in paired uplink and downlink bands). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to FDD in paired uplink and downlink bands). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of FDD in paired uplink and downlink bands as described herein. For example, the communications manager 620 may include a downlink band measurement component 625, an uplink band measurement component 630, an uplink transmission parameter component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The downlink band measurement component 625 is capable of, configured to, or operable to support a means for receiving a first downlink reference signal in a first frequency band to determine one or more first channel conditions associated with the first frequency band, the first downlink reference signal associated with downlink communications. The uplink band measurement component 630 is capable of, configured to, or operable to support a means for receiving a second downlink reference signal in a second frequency band to determine one or more second channel conditions associated with the second frequency band, the second downlink reference signal associated with uplink communications. The uplink transmission parameter component 635 is capable of, configured to, or operable to support a means for transmitting one or more uplink signals in the second frequency band in accordance with one or more transmission parameters that are based on the one or more second channel conditions determined using the second downlink reference signal.

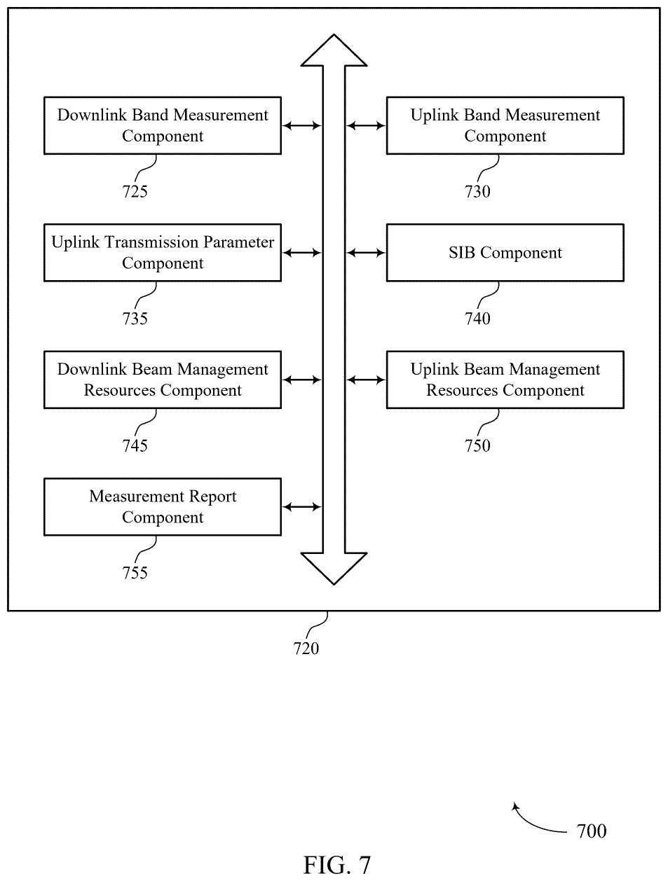

FIG. 7 shows a block diagram 700 of a communications manager 720 that supports FDD in paired uplink and downlink bands in accordance with one or more aspects of the present disclosure. The communications manager 720 may be an example of aspects of a communications manager 520, a communications manager 620, or both, as described herein. The communications manager 720, or various components thereof, may be an example of means for performing various aspects of FDD in paired uplink and downlink bands as described herein. For example, the communications manager 720 may include a downlink band measurement component 725, an uplink band measurement component 730, an uplink transmission parameter component 735, an SIB component 740, a downlink beam management resources component 745, an uplink beam management resources component 750, a measurement report component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The downlink band measurement component 725 is capable of, configured to, or operable to support a means for receiving a first downlink reference signal in a first frequency band to determine one or more first channel conditions associated with the first frequency band, the first downlink reference signal associated with downlink communications. The uplink band measurement component 730 is capable of, configured to, or operable to support a means for receiving a second downlink reference signal in a second frequency band to determine one or more second channel conditions associated with the second frequency band, the second downlink reference signal associated with uplink communications. The uplink transmission parameter component 735 is capable of, configured to, or operable to support a means for transmitting one or more uplink signals in the second frequency band in accordance with one or more transmission parameters that are based on the one or more second channel conditions determined using the second downlink reference signal.

In some examples, the SIB component 740 is capable of, configured to, or operable to support a means for receiving, during an access procedure to a serving cell, an SIB message that indicates a first set of parameters for the first frequency band and a second set of parameters for the second frequency band.

In some examples, the first set of parameters and the second set of parameters include different subcarrier spacings, ARFCNs, cyclic prefixes, or any combination thereof.

In some examples, the downlink beam management resources component 745 is capable of, configured to, or operable to support a means for receiving an indication of a first set of beam management resources associated with the first frequency band. In some examples, the uplink beam management resources component 750 is capable of, configured to, or operable to support a means for receiving an indication of a second set of beam management resources associated with the second frequency band, where the second set of beam management resources are different than the first set of beam management resources.

In some examples, the downlink band measurement component 725 is capable of, configured to, or operable to support a means for measuring one or more downlink reference signals via the first set of beam management resources. In some examples, the measurement report component 755 is capable of, configured to, or operable to support a means for reporting, via a component carrier associated with the downlink communications, an RSRP, a SINR, or both based on measuring the one or more downlink reference signals.

In some examples, the uplink band measurement component 730 is capable of, configured to, or operable to support a means for measuring one or more downlink reference signals via the second set of beam management resources. In some examples, the measurement report component 755 is capable of, configured to, or operable to support a means for reporting, via a first component carrier associated with the uplink communications and via a corresponding second component carrier associated with the downlink communications, an RSRP, a SINR, or both based on measuring the one or more downlink reference signals.

In some examples, the first frequency band and the second frequency band are assigned a same band number, or the first frequency band is assigned a first band number and the second frequency band is assigned a second band number different than the first band number, the first band number and the second band number including a band number pair.

In some examples, the second downlink reference signal is received via a serving cell of the UE.

In some examples, the second downlink reference signal is received via a non-serving cell of the UE.

In some examples, the second downlink reference signal is received via a same component carrier as or a different component carrier than a component carrier associated with the uplink communications.

In some examples, the second frequency band is separated from the first frequency band by at least a threshold frequency separation.

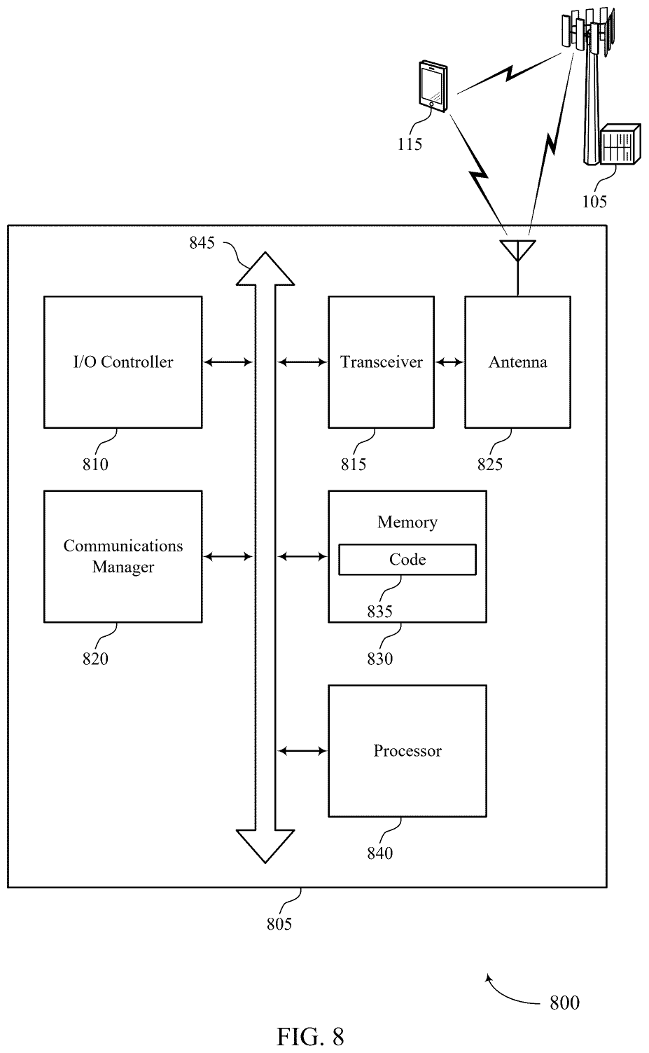

FIG. 8 shows a diagram of a system 800 including a device 805 that supports FDD in paired uplink and downlink bands in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting FDD in paired uplink and downlink bands). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a first downlink reference signal in a first frequency band to determine one or more first channel conditions associated with the first frequency band, the first downlink reference signal associated with downlink communications. The communications manager 820 is capable of, configured to, or operable to support a means for receiving a second downlink reference signal in a second frequency band to determine one or more second channel conditions associated with the second frequency band, the second downlink reference signal associated with uplink communications. The communications manager 820 is capable of, configured to, or operable to support a means for transmitting one or more uplink signals in the second frequency band in accordance with one or more transmission parameters that are based on the one or more second channel conditions determined using the second downlink reference signal.

By including or configuring the communications manager 820 in accordance with examples as described herein, the device 805 may support techniques for reduced latency, improved coverage, more flexible resource adaptation, reduced interference, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of FDD in paired uplink and downlink bands as described herein, or the at least one processor 840 and the at least one memory 830 may be otherwise configured to, individually or collectively, perform or support such operations.

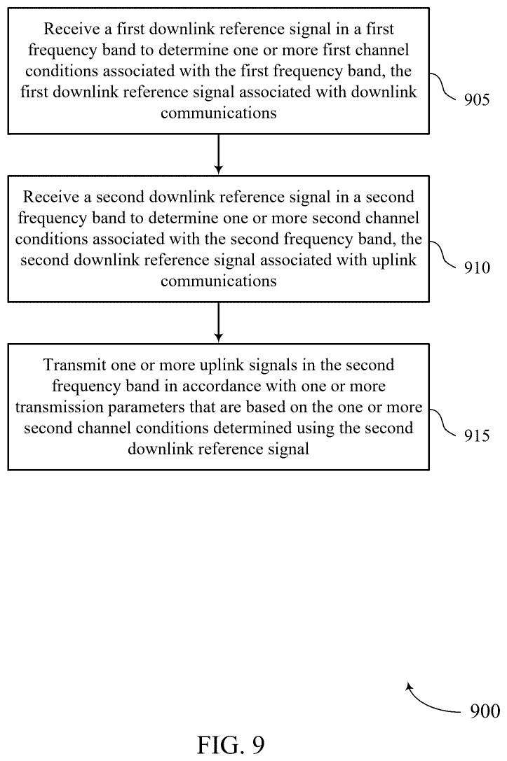

FIG. 9 shows a flowchart illustrating a method 900 that supports FDD in paired uplink and downlink bands in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a first downlink reference signal in a first frequency band to determine one or more first channel conditions associated with the first frequency band, the first downlink reference signal associated with downlink communications. The operations of 905 may be performed in accordance with examples as disclosed herein. In some examples, aspects of the operations of 905 may be performed by a downlink band measurement component 725 as described with reference to FIG. 7.

At 910, the method may include receiving a second downlink reference signal in a second frequency band to determine one or more second channel conditions associated with the second frequency band, the second downlink reference signal associated with uplink communications. The operations of 910 may be performed in accordance with examples as disclosed herein. In some examples, aspects of the operations of 910 may be performed by an uplink band measurement component 730 as described with reference to FIG. 7.

At 915, the method may include transmitting one or more uplink signals in the second frequency band in accordance with one or more transmission parameters that are based on the one or more second channel conditions determined using the second downlink reference signal. The operations of 915 may be performed in accordance with examples as disclosed herein. In some examples, aspects of the operations of 915 may be performed by an uplink transmission parameter component 735 as described with reference to FIG. 7.

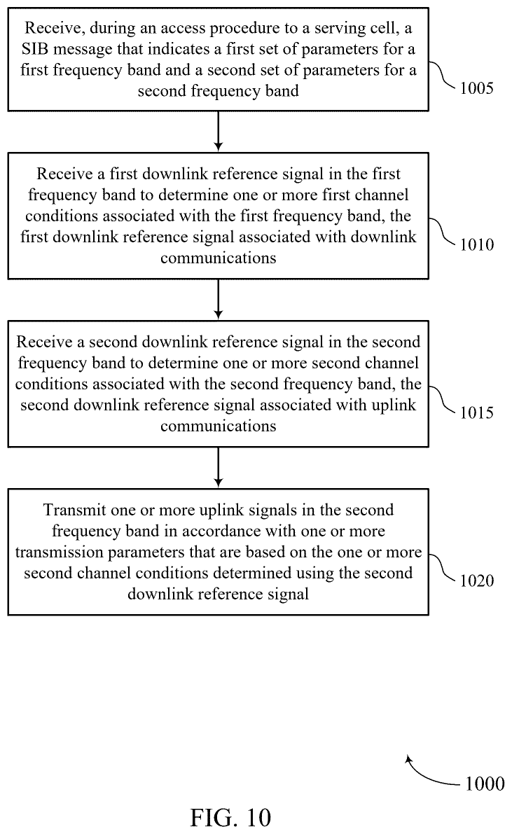

FIG. 10 shows a flowchart illustrating a method 1000 that supports FDD in paired uplink and downlink bands in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, during an access procedure to a serving cell, a SIB message that indicates a first set of parameters for a first frequency band and a second set of parameters for a second frequency band. The operations of 1005 may be performed in accordance with examples as disclosed herein. In some examples, aspects of the operations of 1005 may be performed by an SIB component 740 as described with reference to FIG. 7.

At 1010, the method may include receiving a first downlink reference signal in the first frequency band to determine one or more first channel conditions associated with the first frequency band, the first downlink reference signal associated with downlink communications. The operations of 1010 may be performed in accordance with examples as disclosed herein. In some examples, aspects of the operations of 1010 may be performed by a downlink band measurement component 725 as described with reference to FIG. 7.

At 1015, the method may include receiving a second downlink reference signal in the second frequency band to determine one or more second channel conditions associated with the second frequency band, the second downlink reference signal associated with uplink communications. The operations of 1015 may be performed in accordance with examples as disclosed herein. In some examples, aspects of the operations of 1015 may be performed by an uplink band measurement component 730 as described with reference to FIG. 7.

At 1020, the method may include transmitting one or more uplink signals in the second frequency band in accordance with one or more transmission parameters that are based on the one or more second channel conditions determined using the second downlink reference signal. The operations of 1020 may be performed in accordance with examples as disclosed herein. In some examples, aspects of the operations of 1020 may be performed by an uplink transmission parameter component 735 as described with reference to FIG. 7.

The following provides an overview of aspects of the present disclosure:
Aspect 1: A method for wireless communications by a UE, comprising: receiving a first downlink reference signal in a first frequency band to determine one or more first channel conditions associated with the first frequency band, the first downlink reference signal associated with downlink communications; receiving a second downlink reference signal in a second frequency band to determine one or more second channel conditions associated with the second frequency band, the second downlink reference signal associated with uplink communications; and transmitting one or more uplink signals in the second frequency band in accordance with one or more transmission parameters that are based at least in part on the one or more second channel conditions determined using the second downlink reference signal.
Aspect 2: The method of aspect 1, further comprising: receiving, during an access procedure to a serving cell, an SIB message that indicates a first set of parameters for the first frequency band and a second set of parameters for the second frequency band.
Aspect 3: The method of aspect 2, wherein the first set of parameters and the second set of parameters comprise different subcarrier spacings, ARFCNs, cyclic prefixes, or any combination thereof.
Aspect 4: The method of any of aspects 1 through 3, further comprising: receiving an indication of a first set of beam management resources associated with the first frequency band; and receiving an indication of a second set of beam management resources associated with the second frequency band, wherein the second set of beam management resources are different than the first set of beam management resources.
Aspect 5: The method of aspect 4, further comprising: measuring one or more downlink reference signals via the first set of beam management resources; and reporting, via a component carrier associated with the downlink communications, a RSRP, a SINR, or both based at least in part on measuring the one or more downlink reference signals.
Aspect 6: The method of any of aspects 4 through 5, further comprising: measuring one or more downlink reference signals via the second set of beam management resources; and reporting, via a first component carrier associated with the uplink communications and via a corresponding second component carrier associated with the downlink communications, a RSRP, a SINR, or both based at least in part on measuring the one or more downlink reference signals.
Aspect 7: The method of any of aspects 1 through 6, wherein the first frequency band and the second frequency band are assigned a same band number, or the first frequency band is assigned a first band number and the second frequency band is assigned a second band number different than the first band number, the first band number and the second band number comprising a band number pair.
Aspect 8: The method of any of aspects 1 through 7, wherein the second downlink reference signal is received via a serving cell of the UE.
Aspect 9: The method of any of aspects 1 through 8, wherein the second downlink reference signal is received via a non-serving cell of the UE.
Aspect 10: The method of aspect 9, wherein the second downlink reference signal is received via a same component carrier as or a different component carrier than a component carrier associated with the uplink communications.
Aspect 11: The method of any of aspects 1 through 10, wherein the second frequency band is separated from the first frequency band by at least a threshold frequency separation.
Aspect 12: A UE for wireless communications, comprising one or more memories storing processor-executable code, and one or more processors coupled with the one or more memories and individually or collectively operable to execute the code to cause the UE to perform a method of any of aspects 1 through 11.
Aspect 13: A UE for wireless communications, comprising at least one means for performing a method of any of aspects 1 through 11.
Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first downlink reference signal in a first frequency band to determine one or more first channel conditions associated with the first frequency band, the first downlink reference signal associated with downlink communications;
receive a second downlink reference signal in a second frequency band to determine one or more second channel conditions associated with the second frequency band, the second downlink reference signal associated with uplink communications; and
transmit one or more uplink signals in the second frequency band in accordance with one or more transmission parameters that are based at least in part on the one or more second channel conditions determined using the second downlink reference signal.

2. The UE of claim 1, wherein the one or more processors are individually or collectively further operable to execute the code to cause the UE to:
receive, during an access procedure to a serving cell, a system information block (SIB) message that indicates a first set of parameters for the first frequency band and a second set of parameters for the second frequency band.

3. The UE of claim 2, wherein the first set of parameters and the second set of parameters comprise different subcarrier spacings, absolute radio frequency channel numbers (ARFCNs), cyclic prefixes, or any combination thereof.

4. The UE of claim 1, wherein the one or more processors are individually or collectively further operable to execute the code to cause the UE to:
receive an indication of a first set of beam management resources associated with the first frequency band; and
receive an indication of a second set of beam management resources associated with the second frequency band, wherein the second set of beam management resources are different than the first set of beam management resources.

5. The UE of claim 4, wherein the one or more processors are individually or collectively further operable to execute the code to cause the UE to:
measure one or more downlink reference signals via the first set of beam management resources; and
report, via a component carrier associated with the downlink communications, a reference signal received power (RSRP), a signal-to-interference noise ratio (SINR), or both based at least in part on measuring the one or more downlink reference signals.

6. The UE of claim 4, wherein the one or more processors are individually or collectively further operable to execute the code to cause the UE to:
measure one or more downlink reference signals via the second set of beam management resources; and
report, via a first component carrier associated with the uplink communications and via a corresponding second component carrier associated with the downlink communications, a reference signal received power (RSRP), a signal-to-interference noise ratio (SINR), or both based at least in part on measuring the one or more downlink reference signals.

7. The UE of claim 1, wherein the first frequency band and the second frequency band are assigned a same band number, or the first frequency band is assigned a first band number and the second frequency band is assigned a second band number different than the first band number, the first band number and the second band number comprising a band number pair.

8. The UE of claim 1, wherein the second downlink reference signal is received via a serving cell of the UE.

9. The UE of claim 1, wherein the second downlink reference signal is received via a non-serving cell of the UE.

10. The UE of claim 9, wherein the second downlink reference signal is received via a same component carrier as or a different component carrier than a component carrier associated with the uplink communications.

11. The UE of claim 1, wherein the second frequency band is separated from the first frequency band by at least a threshold frequency separation.

12. A method for wireless communications by a user equipment (UE), comprising:
receiving a first downlink reference signal in a first frequency band to determine one or more first channel conditions associated with the first frequency band, the first downlink reference signal associated with downlink communications;
receiving a second downlink reference signal in a second frequency band to determine one or more second channel conditions associated with the second frequency band, the second downlink reference signal associated with uplink communications; and
transmitting one or more uplink signals in the second frequency band in accordance with one or more transmission parameters that are based at least in part on the one or more second channel conditions determined using the second downlink reference signal.

13. The method of claim 12, further comprising:
receiving, during an access procedure to a serving cell, a system information block (SIB) message that indicates a first set of parameters for the first frequency band and a second set of parameters for the second frequency band.

14. The method of claim 13, wherein the first set of parameters and the second set of parameters comprise different subcarrier spacings, absolute radio frequency channel numbers (ARFCNs), cyclic prefixes, or any combination thereof.

15. The method of claim 12, further comprising:
receiving an indication of a first set of beam management resources associated with the first frequency band; and
receiving an indication of a second set of beam management resources associated with the second frequency band, wherein the second set of beam management resources are different than the first set of beam management resources.

16. The method of claim 15, further comprising:
measuring one or more downlink reference signals via the first set of beam management resources; and
reporting, via a component carrier associated with the downlink communications, a reference signal received power (RSRP), a signal-to-interference noise ratio (SINR), or both based at least in part on measuring the one or more downlink reference signals.

17. The method of claim 15, further comprising:
measuring one or more downlink reference signals via the second set of beam management resources; and
reporting, via a first component carrier associated with the uplink communications and via a corresponding second component carrier associated with the downlink communications, a reference signal received power (RSRP), a signal-to-interference noise ratio (SINR), or both based at least in part on measuring the one or more downlink reference signals.

18. The method of claim 12, wherein the first frequency band and the second frequency band are assigned a same band number, or the first frequency band is assigned a first band number and the second frequency band is assigned a second band number different than the first band number, the first band number and the second band number comprising a band number pair.

19. A non-transitory computer-readable medium storing code for wireless communications, the code comprising instructions executable by one or more processors to:
receive a first downlink reference signal in a first frequency band to determine one or more first channel conditions associated with the first frequency band, the first downlink reference signal associated with downlink communications;
receive a second downlink reference signal in a second frequency band to determine one or more second channel conditions associated with the second frequency band, the second downlink reference signal associated with uplink communications; and
transmit one or more uplink signals in the second frequency band in accordance with one or more transmission parameters that are based at least in part on the one or more second channel conditions determined using the second downlink reference signal.

20. The non-transitory computer-readable medium of claim 19, wherein the instructions are further executable by the one or more processors to:
receive, during an access procedure to a serving cell, a system information block (SIB) message that indicates a first set of parameters for the first frequency band and a second set of parameters for the second frequency band.
